(19) United States
(12) Patent Application Publication
(10) Pub. No.: US 2025/0137348 A1
(43) Pub. Date: May 1, 2025

(54) SUBTERRANEAN FORMATION FUNCTIONALIZATION FOR PERMEATION SELECTIVITY

(71) Applicant: SAUDI ARABIAN OIL COMPANY, Dhahran (SA)

(72) Inventors: Adrian Cesar CAVAZOS SEPULVEDA, Nuevo Leon (MX); Faisal M. ALISSA, Dhahran (SA)

(73) Assignee: SAUDI ARABIAN OIL COMPANY, Dhahran (SA)

(21) Appl. No.: 18/493,969

(22) Filed: Oct. 25, 2023

(51) Int. Cl. E21B 33/138; C09K 8/506; E21B 43/16

(52) U.S. Cl. CPC E21B 33/138; C09K 8/506; E21B 43/16

(57) ABSTRACT

Methods and systems for selectively altering permeability of a subterranean formation rock surface. The methods and systems include introducing a treatment fluid into a target zone in a wellbore drilled through a subterranean formation comprising a plurality of surface flow modifiers (SFMs). The SFMs are selected from the group consisting of a superhydrophobic chemical, a superomniphobic chemical, an ionic liquid chemical, and any combination thereof. The SFMs bind to the rock surface of the subterranean formation within the wellbore at the target zone to at least partially obstruct a rock pore thereof and alter permeation of the rock surface to favor hydrocarbon permeation over water permeation.

### FIELD OF INVENTION

The present disclosure relates generally to methods and systems for use in the oil and gas industry, and more particularly, to compositions, methods, and systems for functionalization of natural subterranean formation rock for fluid permeation selectivity.

### BACKGROUND

The production of crude oil and other hydrocarbons starts with the drilling of a wellbore into a hydrocarbon reservoir. In many cases, the hydrocarbon reservoir is a narrow layer of material in the subterranean environment, wherein other layers have high water content. Indeed, it is believed that most hydrocarbon-bearing subterranean formations were completely or substantially completely saturated with water prior to drilling and tapping into hydrocarbons. Thus, hydrocarbon reservoirs typically contain both petroleum hydrocarbons (liquid and gas) and water. Sources of water in a hydrocarbon reservoir may include flow from above or below the hydrocarbon zone, flow from within the hydrocarbon zone, or flow from injected fluids or other additives as a result of activities such as drilling, completion, and/or production.

As a well is produced, previously productive hydrocarbon-bearing layers may start producing higher amounts of water. Excessive water production greatly affects the economic life of producing wells and is also responsible for many damage mechanisms related to oilfield equipment, such as scale deposition, fines migration, asphaltene precipitation, pin-hole leaks, and corrosion. To combat the effects of produced water, current techniques employ inhibitors, such as scale inhibitors and corrosion inhibitors. Generally, scale inhibitors are utilized throughout an entire production process, and corrosion inhibitors are typically used in surface facilities-both representing sizable operational costs. Moreover, neither address water production, the excess of which can lead to additional increased operating costs and energy requirements to separate, treat, and dispose of the produced water in accordance with applicable environmental regulations.

Available strategies have been employed to mitigate the incursion of water into hydrocarbon producing wellbores. These strategies involve mechanical or chemical “shut off” techniques designed to block water-bearing channels, fractures, or vugular (“vug”) zones. Mechanical shut off techniques include installation of straddle packers, bridge plugs, casing patches, cement plugs, and the like. Such mechanical shut off techniques can, among other things, physically restrict flow within the wellbore and prevent certain treatment operations (e.g., perforation and isolation). Chemical shut off techniques typically involve introduction of gel-based fluids (e.g., polyacrylamide gels) and/or sealant materials into the pore matrix of a formation to reduce water permeability and, thus, water seepage. However, such chemical shut off materials are often unusable in certain geographical regions, particularly those with strict environmental regulations. Moreover, available mechanical and chemical shut off techniques typically require costly logging operations to identify water-producing zones within a subterranean formation to provide effective water shut off.

In light of the aforementioned issues with current water shut off technologies, it is desirable to have an improved shut off technique to control unwanted water incursion into a hydrocarbon-bearing wellbore. Moreover, it is generally desirable to have a general improved technique for fluid permeation selectivity in a hydrocarbon-bearing wellbore, regardless of whether prevention of water incursion or prevention of oil incursion is necessary.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In one or more aspects, the present disclosure provides a method including introducing a treatment fluid into a target zone in a wellbore drilled through a subterranean formation, the treatment fluid comprising: a solvent-based carrier fluid; and a plurality of surface flow modifiers (SFMs), wherein the SFMs are selected from the group consisting of a hydrophobic chemical, a superhydrophobic chemical, an omniphobic chemical, a superomniphobic chemical, an ionic liquid chemical, and any combination thereof; bonding at least a portion of the plurality of SFMs to a rock surface of the subterranean formation within the wellbore at the target zone to at least partially obstruct a rock pore thereof with the SFMs, thereby altering permeation of the rock surface of the subterranean formation to favor hydrocarbon permeation over water permeation through the rock surface of the subterranean formation and into the wellbore; producing hydrocarbons into the wellbore through the rock surface of the subterranean formation; and recovering the hydrocarbons at a surface location.

In another aspect, the present disclosure provides a system including a pump fluidly coupled to a tubular, the tubular extending into a target zone in a wellbore drilled through a subterranean formation and containing a treatment fluid, the treatment fluid comprising: a solvent-based carrier fluid; and a plurality of surface flow modifiers (SFMs), wherein the SFMs are selected from the group consisting of a superhydrophobic chemical, a superomniphobic chemical, an ionic liquid chemical, and any combination thereof, and wherein at least a portion of the SFMs bind to a rock surface of the subterranean formation at the target zone in the wellbore to at least partially obstruct a rock pore thereof with the SFMs and alter permeation thereof to favor hydrocarbon permeation over water permeation.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1A is a schematic drawing of a method of introducing a treatment fluid comprising the surface flow-modifiers described herein into a wellbore to prevent or mitigate coproduction of water, according to one or more aspects of the present disclosure.

FIG. 1B is a schematic drawing of a method to prevent or mitigate coproduction of water into a wellbore using the surface flow modifiers described herein, according to one or more aspects of the present disclosure.

FIG. 1C is a schematic drawing of a method to prevent or mitigate coproduction of water into a wellbore using the surface flow modifiers described herein, according to one or more aspects of the present disclosure.

FIG. 2 is a schematic drawing of a system that can deliver the treatment fluids comprising the surface flow-modifiers described herein to a subterranean (downhole) location, according to one or more aspects of the present disclosure.

### DETAILED DESCRIPTION

The present disclosure relates generally to methods and systems for use in the oil and gas industry, and more particularly, to compositions, methods, and systems for functionalization of subterranean formation rock for fluid permeation selectivity.

The present disclosure provides a chemical shut off solution for selectively influencing the permeability of natural subterranean formation rock surfaces within a wellbore to effectively mitigate or prevent water and/or oil seepage into a wellbore from water-producing zones. Generally, the present disclosure is described with reference to mitigation or prevention of water seepage, as described above. However, it is to be understood that the present disclosure may relate to mitigation or prevention of oil seepage (e.g., if the wellbore is a intended for production or containment/storage of water).

Embodiments described herein provide surface flow modifiers (“SFMs”) that are advantageously able to selectively permit flow of hydrocarbons through a water-producing zone of a subterranean formation (“zone of interest”) penetrated by a wellbore, while simultaneously mitigating or preventing the flow of naturally-occurring water produced therethrough, via surface selective functionalization. Moreover, the SFMs of the present disclosure are suitable for use in upstream conditions that historically are damaging to other well shut off methods utilizing ceramics (e.g., alumina, titania, zirconia, silica). Alternatively, the SFMs of the present disclosure may be advantageously able to selectively permit flow of water through a water-producing zone of a subterranean formation (“zone of interest”) penetrated by a wellbore, while simultaneously mitigating or preventing the flow of oil produced therethrough, via surface selective functionalization.

The SFMs of the present disclosure confer properties to the surface and pores (including fractures) of subterranean formation rock via chemical (e.g., covalent bonding, ionic bonding, hydrogen bonding) and/or physical bonding (e.g., absorption, Van der Waal's forces, impregnation, entrapment, grafting) based on a superhydrophobic chemical, a superomniphobic chemical, a superoleophobic chemical, an ionic liquid (“IL”) chemical, and any combination thereof. These SFMs may include, but are not limited to, an organophosphorous, an organosilane, an organometallic, an IL, and any combination thereof.

These SFMs may include, but are not limited to, a phosphate derivative (R—PO₃H₂, (R₁)(R₂)(R₃)P, (R₁)(R₂)(R₃)PO, (OR₁)(OR₂)(OR₃)PO or (OR₁)(OR₂)(OR₃) P) (organophosphorous), an alkoxysilane (R₁—Si—(OR₂)₃) (organosilane), a silyl halide (R—Si—(X)₃) (organometallic (in the form of organosilicone)), a Grignard-based reagent (R—MgBr), a Gilman-based reagent (R₂—CuLi) (organometallic), an organolithium (R—Li) (organometallic), an organozinc (R₂—Zn) (organometallic), an ionic liquid (“IL”), and any combination thereof. In the aforementioned SFM examples, R is a carbon chain comprising fluorocarbons (C—Fₓ bonds), R is a hydrocarbon containing C—H chains (C—H bonds) or R is a carbon chain comprising fluorocarbons (C—Fₓ bonds) and C—H chains (C—H bonds). Moreover, the SFMs of the present disclosure may be tuned or otherwise chosen to be selective for a particular subterranean formation type (e.g., carbonate, sandstone) to permit selective permeation of hydrocarbons and mitigation or prevention of permeation of water. Accordingly, the compositions, methods, and systems of the present disclosure effectively convert the natural rock surface (e.g., wellbore surface, fracture surface, pore surface, and the like) of a subterranean formation into a selective membrane.

It is to be appreciated that while the present disclosure discusses the selective permeation of subterranean formation rock surfaces via the SFMs described herein with reference to hydrocarbons (oil and/or gas) and water, the SFMs may be used to prevent various gases (e.g., CO2) from permeating the rock surface into a wellbore, while permitting permeation of hydrocarbons. Moreover, the SFMs may prevent permeation of one of a gaseous or liquid fluid, while permitting permeation of the other type of fluid, without departing from the scope of the present disclosure.

### Definitions

As used herein, the term “subterranean formation,” and grammatical variants thereof, refers to naturally occurring rock beneath the Earth's surface, including subsea surfaces. Subterranean formations may be formed from a variety of natural rock including, but not limited to, carbonate-based rock (e.g., calcium carbonate (CaCO₃)), calcium magnesium carbonate (CaMg(CO₃)₂) (also referred to as dolomite), sandstone-based rock comprising clays (e.g., smectite, illite, kaolinite, chlorite, and the like) and minerals (e.g., silica) and the like, and any combination thereof). The subterranean formations described herein encompass reservoir zones (i.e., zones comprising hydrocarbons (oil and/or gas)) and non-reservoir zones (i.e., zones that do not comprise hydrocarbons, such as water-producing zones).

As used herein, the term “wellbore,” and grammatical variants thereof, refers to a drilled hole or borehole penetrating a subterranean formation, which may be cased (cemented) or uncased (openhole).

As used herein, the term “water-producing zone,” and grammatical variants thereof, refers to an interval or unit of a subterranean formation penetrated by a wellbore through which naturally-occurring water is produced into the wellbore along with hydrocarbon oil and/or gas fluids.

As used herein, the term “carbon dioxide-producing zone,” and grammatical variants thereof, refers to an interval or unit of a subterranean formation penetrated by a wellbore through which naturally-occurring carbon dioxide is produced into the wellbore along with hydrocarbon oil and/or gas fluids.

As used herein, the term “produced fluid,” and grammatical variants thereof, refers to any fluid produced from a wellbore penetrating a subterranean formation that is not an introduced treatment fluid (e.g., drilling fluid, fracturing fluid, acidizing fluid, and the like).

As used herein, the terms “water shut off” or “shut off,” and grammatical variants thereof, refers to the mitigation or complete prevention of unwanted water production within a wellbore.

As used herein, the term “water,” and grammatical variants thereof, refers to any water-based fluid including, but not limited to, fresh water, saltwater (e.g., water containing one or more salts dissolved therein), brine (e.g., saturated salt water), seawater, produced water, and the like, and any combination thereof.

As used herein, the terms “surface flow modifier” or “SFM,” and grammatical variants thereof, refers to chemistry (e.g., a chemical compound) that modifies the permeability of a rock surface or pore (e.g., a subterranean formation rock surface or pore) such that the rock surface or pore is permeable to a first fluid and impermeable (or substantially impermeable) to a second fluid that is different than the first fluid in hydrophobicity/hydrophilicity. In the embodiments herein, one fluid is a hydrophobic hydrocarbon (oil and/or gas) and the second fluid is hydrophobic water-based fluid, wherein the SFM(s) prevent or reduce permeation of water into a wellbore while allowing permeation of the hydrocarbon fluid. As used herein, the term “substantially impermeable,” and grammatical variants thereof, refers to a prevention of at least about 1 vol % of a fluid through a permeable rock (into a wellbore), including up to 100 vol %, encompassing any value and subset therebetween.

As used herein, the term “surface selective functionalization,” and grammatical variants thereof, refers to an SFM comprising at least a first functional group that reacts and bonds with a rock surface or pore (e.g., subterranean formation rock surface or pore) and at least a second functional group that provides (alone or in combination with the first functional group(s)) surface selective permeation of a hydrocarbon fluid and a water fluid, the combination being an SFM, as described herein.

As used herein, the term “hydrophobic chemical,” and grammatical variants thereof, refers to a chemical compound that repels water (hydrophilic fluid).

As used herein, the term “superhydrophobic chemical,” and grammatical variants thereof, refers to a chemical compound that repels water (hydrophilic fluid) to a degree that the water droplets do not flatten, but roll away from a surface (a “superhydrophobic surface”). Superhydrophobic surfaces (including pore surfaces) generally have a static water contact angle above about 150° and a contact angle hysteresis of less than about 5°.

As used herein, the term “omniphobic chemical,” and grammatical variants thereof, refers to a chemical compound that repels fluids generally (without regard to hydrophobicity or hydrophilicity).

As used herein, the term “superomniphobic chemical,” and grammatical variants thereof, refers to a chemical compound that repels fluids generally (without regard to hydrophobicity or hydrophilicity) to a degree that the water droplets do not flatten, but roll away from a surface (a “superomniphobic surface”). Superomniphobic surfaces (including pore surfaces) generally have a static water contact angle above about 150° and a low contact angle hysteresis. Accordingly, the superomniphobic chemical may repel oil or water, depending on the particular superomniphobic chemical selected, the subterranean formation chemistry, and the like, and any combination thereof.

As used herein, the term “oleophobic chemical,” and grammatical variants thereof, refers to a chemical compound that repels oil and oil-based materials.

As used herein, the term “superoleophobic chemical,” and grammatical variants thereof, refers to a chemical compound that repels oil to a degree that the oil rolls away from a surface (a “superoleophobic surface”). Superoleophobic surfaces (including pore surfaces) have a static oil contact angel above about 150° C. and a dynamic angle of less than about 10°. For a surface to be hydrophobic, the surface free energy of the material (e.g., solid) must be lower than the surface tension of water (˜72.8 millinewton per meter (mN/m)). However, for a surface to be oleophobic, the surface free energy must be lower than about 20 mN/m, which is a typical surface tension value for oil, where such low surface tension requires surface property engineering (e.g., chemistry, roughness). Accordingly, the superoleophobic chemical may repel oil, such as in the case of use in a wellbore intended for water production and/or water containment/storage.

As used herein, the terms “ionic liquid chemical” or “IL,” and grammatical variants thereof, refer to a molten salt in a liquid state at temperatures below about 100° C. ILs consist entirely of cations and anions in the absence of any molecular solvents, and may both be organic or inorganic ions interchangeably. The terms “ionic liquid chemical” and “IL,” and grammatical variants thereof, encompasses ionic liquids, supported ionic liquid membranes (“SILM”), polymeric ionic liquids (“PIL”), zwitterionic liquids (“ZIL”), ionic liquid gels (“ILG,” also referred to in the industry as “ionogels”), task specific ILs, responsive ILs, and any combination thereof.

As used herein, the term “treatment fluid,” and grammatical variants thereof, refers to a fluid comprising a solvent-based carrier fluid and a plurality of SFMs, according to the present disclosure. The plurality of SFMs may be identical in composition or vary in composition, without departing from the scope of the present disclosure.

As used herein, the term “squeeze” or “squeeze job,” and grammatical variants thereof, refers to application of predetermined pump pressure to provide a treatment fluid to a particular zone of interest (e.g., a water-producing zone). Generally, such application is performed at a downhole injection pressure below the formation fracture pressure.

### Selective Permeability SFM Compositions

As provided above, the SFMs of the present disclosure may comprise a hydrophobic chemical, a superhydrophobic chemical, an omniphobic chemical, a superomniphobic chemical, an IL chemical, and any combination thereof. In one or more aspects, the SFM may comprise a superoleophobic chemical alone or in combination with one or more of the aforementioned SFMs (e.g., for use in repelling oil in wellbores intended for water production and/or water containment/storage).

The SFMs may include, but are not limited to, an organophosphorous, an organosilane, a fluorocarbon, an organometallic, an IL, and any combination thereof.

In one or more aspects, the SFMs are composed primarily of two portions: a head portion comprising one or more functional groups and a tail portion comprising one or more functional groups. As described below, generally, the head portion function group(s) of these SFMs react and bond to the mineral surface of subterranean formation rock and the tail portion function group(s) reduce the permeation of water through the rock (e.g., and into a wellbore), while permitting permeation of hydrocarbons (e.g., into the wellbore). Thus, the tail portion functional group(s) interact with hydrophilic (to prevent permeation) and hydrophobic (to allow permeation) of produced fluids from a subterranean formation and into a wellbore. The prevention of unwanted permeation into the wellbore may be in the range of about 1% to about 100%, encompassing any value and subset therebetween.

The functional group(s) of the head portion of the SFMs react with the mineral surface of a subterranean formation penetrated by a wellbore, including pore and/or fracture surfaces therein, and is therefore selected based on the particular subterranean formation rock composition. In one or more aspects, the head portion of the SRM comprises one or more compounds associated with one or more formation-matching functional groups that facilitate a chemical and/or physical reaction between the head portion and the formation rock to bond the SFM to the rock surface. Such compounds may include, but are not limited to, a silane compound, a siloxy compound, an aluminoxy compound, an aluminosilicate compound, a chloroaluminate compound, and any combination thereof.

The tail portion is exposed to produced fluids. The tail portion of the SFMs serves primarily (alone or in combination with the head portion) to selectively modify the permeability of the formation rock surface to select for permeation of hydrocarbons (oil and/or gas) and mitigate (render substantially impermeable) or wholly prevent permeation of water into a wellbore through the formation rock surface. The tail portion is critical to achieve the selective permeability of hydrocarbons over water (i.e., the altered, selective permeation favors hydrocarbons over water). The tail portion requires long chain carbons to achieve the desired fluid selective permeability and generally comprises a hydrocarbon chain having between four (4) and thirty (30) carbon atoms, encompassing any value and subset therebetween. The tail portion may include, but is not limited to, an aliphatic cyclic compound, an aliphatic linear compound, an aromatic cyclic compound, or an aromatic linear compound.

As provided above, the SFMs may include a phosphate derivative (R—PO₃H₂) (organophosphorous), an alkoxysilane (R₁—Si—(OR₂)₃) (organosilane), a silyl halide (R—Si—(X)₃) (organometallic (in the form of organosilicone)), a Grignard-based reagent (R—MgBr) a Gilman-based reagent (R₂—CuLi) (organometallic), an organolithium (R—Li) (organometallic), an organozinc (R₂—Zn) (organometallic), an IL, and any combination thereof.

Specific examples of suitable SFMs for use in the embodiments of the present disclosure may include, but are not limited to, 1,2-Bis(trimethoxysilyl) decane (organosilane), (2-methyl-2-phenylethyl)methyldichlorosilane (organosilane), 4-phenylbutyldimethylchlorosilane (organosilane), and any combination thereof. The chemical structures of each of these specific SFMs are provided by Structures 1-3 below.

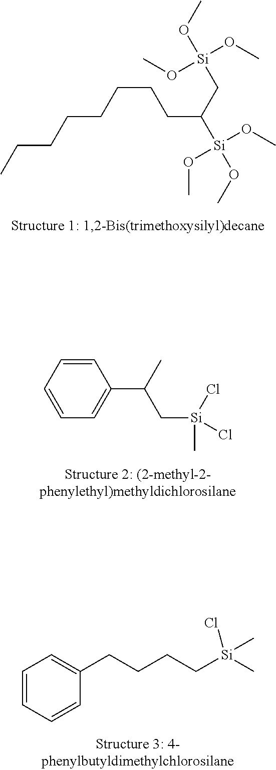 [SMILES: CCCCCCCCC(C[Si](OC)(OC)OC)[Si](OC)(OC)OC ; CC(C[Si](C)(Cl)Cl)c1ccccc1 ; C[Si](C)(Cl)CCCCc1ccccc1]

As provided herein, the SFMs described herein may chemically or physically react with a surface of a subterranean formation rock to bond thereto (e.g., surface of a wellbore, fracture, pore, and the like). In one or more aspects, the SFMs physically absorb or absorb to a formation rock surface (e.g., surface of a wellbore, fracture, pore, and the like). As used herein, the term “bonding,” and grammatical variants thereof, refers to both chemical and physical bonding, including absorption, adsorption, static or electric forces, and any other means of maintaining contact between an SFM and a subterranean formation rock. These absorptive SFMs may comprise any of the aforementioned SFMs that are further modified into a hierarchical or branched particle-like molecule that is dissolvable in select solvents. Examples of such SFMs may include, but are not limited to, fluorinated carbon ended molecules with oligomeric siloxy cores that are primarily soluble in fluorinated organic solvents, such as, for example, a fluorinated polyhedral oligomeric silsesquioxane (F-POSS, a variation of Structure 1 above), hexafluorobenzene, 2H,3H-Perfluoropentane (HFC-43-10), 1,3-Dichloro-1,1,2,2,3-pentafluoropropane (AK-225), and any combination thereof.

In one or more aspects, the SFMs of the present disclosure may be ionic liquids (including SMILs, PILs, ZILs, IGLs), which exhibit properties or absorptive SFMs. These ILs may be supported and/or grafted onto natural subterranean formation rock surfaces in accordance with various embodiments of the present disclosure. ILs are considered relatively green (environmentally-friendly) chemicals that exhibit stability and selective permeability functionality under harsh subterranean formation conditions (e.g., high temperatures, pressures, salinity).

Any suitable ionic liquid may be of use in the present disclosure. Examples of ionic liquids may include, but are not limited to, [B4MPy], [BF4], [PF6], [B3MPy], [TFMS], [EMIM], [B3MIM], [IM], [TFSI], [HMIM], [HSO4], [EMIM], [Tf2N], [EMIM], [TfA], [BMIM], [C3CIMIM], [BMIM], the like, or any combination thereof.

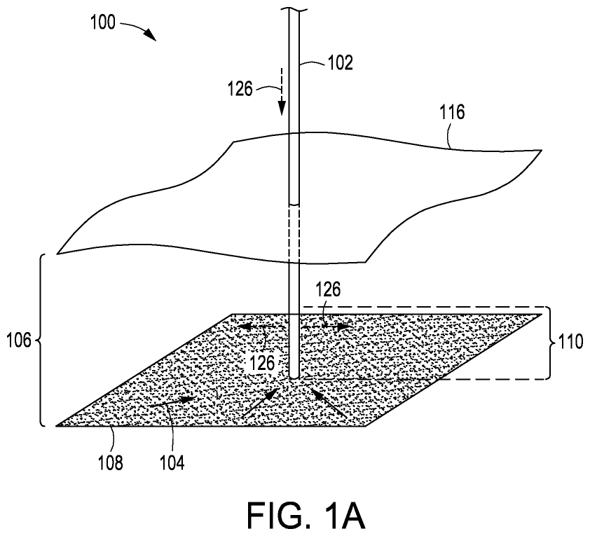

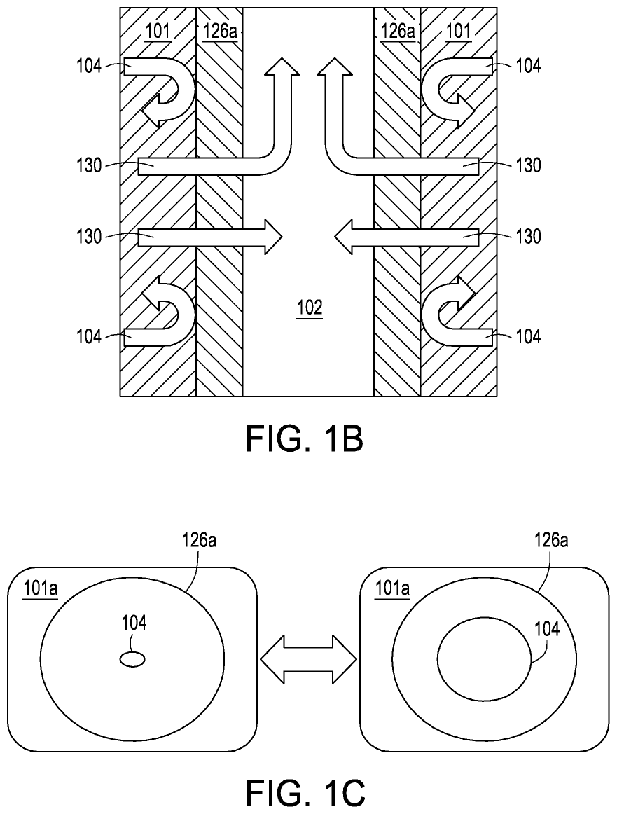

In one or more instances, the selected ILs may become entrapped in the pores of a subterranean formation rock to provide the desired selective permeation of hydrocarbons over water, as provided herein, and/or further react in the presence of hydrocarbons and/or water to provide the selective permeation. That is, in some embodiments, the ILs (including any one or combination of the aforementioned IL types) may be “responsive” and activate under subterranean formation conditions or based on contact with a particular treatment or produced fluid, such as a stimuli produced from one or more of fluid type (e.g., aqueous or oil-based), temperature, ionic strength, and the like, and any combination thereof. For example, an IL may be responsive such that it swells in contact with an aqueous environment and reversibly retracts (shrinks) when surrounded by a hydrocarbon, such as the IL 1-(8-(acryloyloxy) octyl)-3-methylimidazolium. In so doing, the subterranean formation surface (rock) pores within a wellbore may be selectively substantially or completely plugged (e.g., to water due to swelling of the IL) or unplugged (e.g., to oil due to retracting of the IL) thereby influencing the permeability of the subterranean formation of fluids into the wellbore (see FIG. 1C).

As provided above, ILs consist entirely of cations and anions in the absence of any molecular solvents; these cations and anions may be organic or inorganic.

Suitable cations for use in the ILs of the present disclosure may include, but are not limited to, a phosphonium cation, an ammonium cation, an imidazolium cation, a pyrrolidinium cation, a pyridinium cation, a piperidinum cation, a morpholinium cation, a thiazolium cation, a sulphonium cation, a silyl cation, and any combination thereof.

Suitable anions for use in the ILs of the present disclosure may include, but are not limited to a phosphate anion (e.g., an alkylphosphate anion, a hexafluorophosphate anion), an sulfate anion (e.g., an alkylsufate anion), a borate anion (e.g., a tetrafluorborate anion, a tetracyanoborate anion), a sulfonate anion (e.g., a trifluromethylsulfonate anion), an imide anion (e.g., bis(trifluoromethylsulfonyl)imide anion), a cyanimide anion (e.g., a dicyanamide anion), an amine anion (e.g., a lysine anion, a histidine anion, a glutamine anion, an asparagine anion), and any combination thereof.

In one or more instances, the SFMs of the present disclosure may be immobilized by chemical or physical means by impregnation (e.g., absorption, adsorption), sol-gel method, encapsulation, covalent bonding, solidification, gelation, geometrical hindrance, and any combination thereof, to a substrate. In various embodiments, the substrate is porous and allows the SFMs to progressively become mobilized and removed from the substrate for interaction with a subterranean formation rock surface for selective permeation thereof to hydrocarbons over water. In alternative or additional (combination) embodiments, the substrate may be at least partially nonporous and degrade progressively to mobilize the SFMs. In still other embodiments, a porous substrate may additionally degrade progressively to aid in mobilization of the SFMs. In various instances, the immobilization may be achieved by various preparation techniques including, but not limited to, coating of a substrate with SFMs, soaking of a substrate with SFMs, vacuum-assisted infiltration of a substrate with SFMs, and the like, and any combination thereof. Substrates for use in immobilizing and supporting the SFMs described herein may be porous or nonporous. Examples of suitable substrates may include, but are not limited to, porous metal, metallic, and metalloid oxides (e.g., SiO₂, Al₂O₃), degradable polymers (e.g., polylactic acid, polyglycolic acid, waxes), and the like, and any combination thereof. In some instances, the substrate is selected from cuttings, such as drill cuttings, that have been produced to the surface as part of drilling a wellbore. As such, the substrate for immobilizing the SFMs is of the same composition as the subterranean formation for which the SFMs will provide selective permeation of hydrocarbons over water.

The SFMs of the present disclosure (whether or not immobilized) are delivered to a zone of interest (e.g., a water-producing zone) of a subterranean formation through a wellbore in a treatment fluid, such as by squeezing (or via a “squeeze job”) the treatment fluid into the zone of interest. The treatment fluid may comprise a plurality of SFMs and a solvent-based carrier fluid that is neither miscible with hydrocarbons or water, for which the selective permeation of the SFMs is intended to influence. Suitable solvent-based carrier fluids are generally characterized as having relatively high boiling points, such as greater than about 100° C., or in the range of about 100° C. to about 300° C., encompassing any value and subset therebetween, and relatively high flash points in an oxygen-containing environment, such as greater than about 60° C., or in the range of about 60° C. to about 150° C., encompassing any value and subset therebetween.

Examples of suitable solvent-based carrier fluids may include, but are not limited to, dibenzyl ether, diethyleneglycol butyl ether, 2-butoxyethanol, diethylene glycol monobutyl ether acetate, ethylene glycol, hexafluorobenzene, 2H,3H-Perfluoropentane (HFC-43-10), 1,3-Dichloro-1,1,2,2,3-pentafluoropropane (AK-225), and any combination thereof. The particular concentration of SFM used in a wellbore may be dependent on a number of factors including, but not limited to, the particular SFM(s) type, the particular subterranean formation type, the geometry of the wellbore, the volume and location of the zone of interest (e.g., water-producing zone of interest), and the like, and any combination thereof.

### Selective Permeability Surface Flow Modifier Compositions-Carbonate Subterranean Formation Rock

Hydrocarbon wellbores are often drilled in carbonate-based subterranean formations for stimulation thereof (e.g., hydraulic fracturing). These carbonate-based subterranean formations may be composed of at least 50% or greater of one or more carbonate-based compounds. Such carbonate-based compound may include, but are not limited to calcium carbonate (CaCO3) (also referred to as “calcite”), calcium magnesium carbonate (CaMg(CO₃)₂) (also referred to as “dolomite”), and any combination thereof.

SFMs for use in carbonate-based subterranean formations to enhance or permit the permeation of hydrocarbons and mitigate or render impermeable (or substantially impermeable) the permeation of water include those mentioned above. That is, the SFMs may at least partially (or completely) obstruct one or more pores of the rock surface of the subterranean formation. In preferred embodiments, the SFMs for use in carbonate-based subterranean formations include, but are not limited to, a Grignard-based reagent (R—MgBr), a Gilman-based reagent (R₂—CuLi), an organolitium (R—Li), an organozinc (R₂—Zn), an organophosphorous (R—PO₃H₂, (R₁)(R₂)(R₃)P, (R₁)(R₂)(R₃)PO, (OR₁)(OR₂)(OR₃)PO or (OR₁)(OR₂)(OR₃) P) (e.g., that absorbs into carbonate-based subterranean formation rock surfaces), and any combination thereof. In the aforementioned SFM examples, R is a carbon chain comprising fluorocarbons (C—Fₓ bonds), R is a hydrocarbon comprising C—H chains (C—H bonds), or R is a carbon chain comprising fluorocarbons (C—Fₓ bonds) and C—H chains (C—H bonds). Moreover, any reagent capable of producing a carbon with a negative charge (a “carbanion”) may be used in a carbonate-based subterranean formation as an SFM according to the embodiments of the present disclosure.

### Selective Permeability Surface Flow Modifier Compositions-Sandstone Subterranean Formation Rock

Hydrocarbon wellbores are often drilled in clastic, sandstone-based subterranean formations for stimulation thereof (e.g., hydraulic fracturing). Sandstone-based subterranean formations are generally comprised of minerals (e.g., silica, quartz, feldspar) and clays (e.g., smectite, illite kaolinite, chlorite).

SFMs for use in sandstone-based subterranean formations to enhance or permit the permeation of hydrocarbons and mitigate or render impermeable (or substantially impermeable) the permeation of water include those mentioned above.

In preferred embodiments, the SFMs for use in sandstone-based subterranean formations include, but are not limited to, an organosilane, such as those provided in Structures 1-3 (i.e., 1,2-Bis(trimethoxysilyl) decane, (2-methyl-2-phenylethyl)methyldichlorosilane, 4-phenylbutyldimethylchlorosilane, and any combination thereof). Suitable organosilanes may include, but are not limited to, those having the formula R₁—Si(X)(Y)(Z), where X, Y, and Z can be either a halogen, an ethoxy group (OR₂), or a hydrocarbon chain (R₂) in any combination. That is, X, Y, and Z may be the same or different, without limitation.

It is to be appreciated that the SFMs used for sandstone-based subterranean formations may be interchangeably used in shale-based subterranean formations, shale also being a sedimentary rock and primarily composed of clay and siltstone.

### Methods and Systems for Selective Permeability of Hydrocarbons and Water

Various embodiments of the present disclosure will be described in detail with reference to the accompanying chemical structures and Figures. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

### Methods

Referring now to FIG. 1, illustrated is a schematic drawing of a method 100 of providing selective permeability using the SFMs of the present disclosure to a target zone 110 (e.g., water-producing zone) of a wellbore 102 in a subterranean formation 101. It should be noted that target zone 110 may further be a carbon dioxide-producing zone in combination with a water-producing zone. The SFMs impart selective permeability to the subterranean formation 101 at the target zone 110 to decrease coproduction of water by enhancing or allowing permeation of hydrocarbons into the wellbore 102 and mitigating or rendering substantially impermeable the permeation of water into the wellbore 102. In the example shown in FIG. 1, the wellbore 102 is shown as vertical. However, the wellbore 102 can be directionally drilled into the reservoir layer 106 (comprising hydrocarbon producing zone(s) and target zone 110) or otherwise deviated or tortuous.

Water 104 may come from an underlying water table, or water layer 108, below the reservoir layer 106. Alternatively or additionally, the water layer 108 may be located parallel or in any other spatial location relative to the wellbore 102, without departing from the scope of the present disclosure. A section 110 of the wellbore 102 closest to the water layer 108 may draw water 104 into the wellbore 102 during a subterranean formation operation (e.g., during fracturing, hydrocarbon production (e.g., a pumping cycle of a pump jack), enhanced oil recovery) and to the surface 116, thereby resulting in produced water.

The method 100 begins when the produced fluids include an unacceptable amount of water 104, for example, coproduced from a water layer 108. Such unacceptable water may be greater than about 1 vol % of the produced fluids, greater than about 25 vol % of the produced fluids, or in the range of about 1 vol % to about 90 vol % of the produced fluids, encompassing any value and subset therebetween. Alternatively, or in addition, a logging tool or other method may be used to identify water layer 108. The section 110 of the wellbore 102 closest to the water layer 108 may be responsible for the majority of the water 104 that is coproduced.

A treatment fluid 126 according to the present disclosure comprising a solvent-based carrier fluid and a plurality of SFMs, as described herein, is introduced into the wellbore 102 such that the target zone 110 of the subterranean formation 101 forming the wellbore 102 is contacted. The SFMs react and bond (or absorb) with the subterranean formation rock to provide selective permeability of hydrocarbons over water (from the water layer 108) into the wellbore 102.

In operation, coiled tubing or other conduit (not shown) may be used to place two packers (e.g., PX packers) to isolate the target zone 110 into which water 104 may be flowing or may be identified as a risk to flowing from water layer 108. A lower packer may be placed at the lower end of the target zone 110 and an upper packer may be placed at the upper end of the target zone 110 relative to the surface 116. The lower packer is a non-pump-through packer and the upper packer is a pump-through packer. Coiled tubing or other conduit (not shown), which may be the same or different than the coiled tubing or other conduit used to place the packers, may be introduced into the wellbore 102 and through the upper packer (if a new conduit) to introduce (or squeeze) the treatment fluid into the wellbore 102 at the target zone 110. In one or more aspects, after the treatment fluid is placed within the target zone 110 and sufficient time or stimuli (e.g., predetermined time, subterranean formation conditions, and the like) has been allowed for the SFMs in the treatment fluid to react and bind to the subterranean formation 101 surface rock within the wellbore 102, the packers may be removed using the coil tubing or other conduit. In some instances, the SFMs are stimulated chemically to react and bond with subterranean formation rock surfaces. Such chemical stimulation may be based on temperature, ionic strength, pH, (ultra) sonication, electromagnetic radiation, electric discharge, chemical reaction, and any combination thereof.

In one or more embodiments, prior to introducing (squeezing) the treatment fluid between the packers at the target zone 110, a spacer fluid may be introduced that is miscible with the treatment fluid and immiscible with water and hydrocarbons. The spacer fluid may comprise a solvent-based fluid, including, but not limited to, any of those mentioned above with reference to the treatment fluid: dibenzyl ether; diethyleneglycol butyl ether; 2-butoxyethanol; diethylene glycol monobutyl ether acetate; ethylene glycol; diesel; hexafluorobenzene; 2H,3H-perfluoropentane (HFC-43-10); 1,3-dichloro-1,1,2,2,3-pentafluoropropane (AK-22), and any combination thereof. The spacer fluid is used to physically separate the treatment fluid placed into the target zone 110 from other fluids within the wellbore (e.g., drilling fluid, fracturing fluid, and the like).

Referring now to FIG. 1B, and with continued reference to FIG. 1A, like numeric labeling will be used for both FIGS. 1A and 1B where like structures are referenced. As shown in FIG. 1B, a wellbore 102 has been drilled in a subterranean formation 101. A treatment fluid 126 (see FIG. 1A) comprising the SFMs 126a of the present disclosure is introduced into the wellbore 102 and the SFMs 126a comprised therein react and bond to the surface of the subterranean formation 101 within the wellbore 102. The SFMs 126a prevent or mitigate permeation of water 104 (e.g., from a water-producing zone or water layer 108 of FIG. 1A) through the subterranean formation 101 into the wellbore 102, while permitting hydrocarbon production 130 via permeation through the subterranean formation 101 and into the wellbore 102 for recovery at a surface location.

Referring now to FIG. 1C, and with continued reference to FIGS. 1A and 1B, like numeric labeling will be used for FIGS. 1A-1C where like structures are referenced. As described above, in some instances, the SFMs may be responsive ILs. Such responsive ILs may swell or retract in the presence of an aqueous or hydrocarbon fluid, respectively. As shown in FIG. 1C, SFM 126a is a responsive IL and provided in a water-producing subterranean formation zone of interest 101a, such that the SFM 126a is surrounded by aqueous fluid, or provided in a hydrocarbon-producing subterranean formation zone of interest 101b, such that the SFM 126a is surrounded by hydrocarbon (oil) fluid. In the water-producing subterranean formation zone 101a, a pore 104 of the subterranean formation 101a is reduced in size due to swelling of the SFM 126a in the aqueous fluid. In the hydrocarbon-producing subterranean formation zone 101b, the pore 104 of the subterranean formation zone 101b is reduced in size due to retracting of the SFM 126a in the hydrocarbon fluid. As shown by the arrow in FIG. 1C, the swelling and retracting of the SFM 126a is reversible depending upon whether the SFM 126a is in an aqueous fluid or a hydrocarbon fluid, respectively.

### Systems

In various embodiments, systems configured for delivering the treatment fluids comprising the SFMs described herein to a downhole location within a subterranean formation are provided. In various embodiments, the systems can comprise a pump fluidly coupled to a tubular, the tubular containing the treatment fluids described herein.

The pump may be a high pressure pump in some embodiments. As used herein, the term “high pressure pump,” and grammatical variants thereof, refers to a pump that is capable of delivering the treatment fluids downhole at a pressure of about 1000 psi or greater. A high pressure pump may be used when it is desired to introduce the treatment fluids to a subterranean formation at or above a fracture gradient of the subterranean formation, but it may also be used in cases where fracturing is not desired. In some embodiments, the high pressure pump may be capable of fluidly conveying solid particulate matter, such as the solid waste plastics and other solid additives described in some embodiments herein, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump,” and grammatical variants thereof, refers to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluids to the high pressure pump. In such embodiments, the low pressure pump may “step up” the pressure of the treatment fluids before reaching the high pressure pump.

In some embodiments, the systems described herein can further comprise a mixing tank that is upstream of the pump and in which the treatment fluids are formulated. In various embodiments, the pump (e.g., a low pressure pump, a high pressure pump, or a combination thereof) may convey the treatment fluids from the mixing tank or other source of the treatment fluids to the tubular. In other embodiments, however, the treatment fluids may be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluids may be drawn into the pump, elevated to an appropriate pressure, and then introduced into the tubular for delivery downhole.

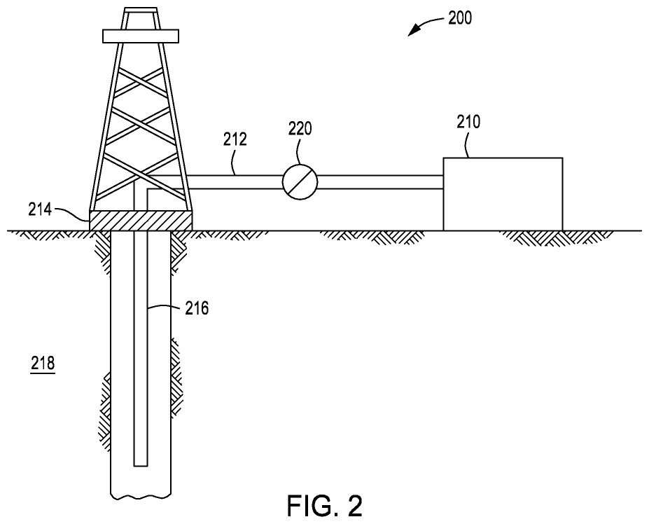

FIG. 2 shows an illustrative schematic of a system that can deliver the treatment fluids of the present disclosure to a downhole location, according to one or more embodiments. It should be noted that while FIG. 2 generally depicts a land-based system, it is to be recognized that like systems may be operated in subsea locations as well. As depicted in FIG. 2, system 200 may include mixing tank 210, in which the treatment fluids of the embodiments herein may be formulated. The treatment fluids may be conveyed via line 212 to wellhead 214, where the treatment fluids enter tubular 216, tubular 216 extending from wellhead 214 into subterranean formation 218. Upon being ejected from tubular 216, the treatment fluids may subsequently penetrate into subterranean formation 218 at a target zone (e.g., target zone 110 of FIG. 1A). Pump 220 may be configured to raise the pressure of the treatment fluids to a desired degree before introduction into tubular 216. It is to be recognized that system 200 is merely exemplary in nature and various additional components may be present that have not necessarily been depicted in FIG. 2 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

While various embodiments have been shown and described herein, modifications may be made by one skilled in the art without departing from the scope of the present disclosure. The embodiments described here are exemplary only, and are not intended to be limiting. Many variations, combinations, and modifications of the embodiments disclosed herein are possible and are within the scope of the disclosure. Accordingly, the scope of protection is not limited by the description set out above, but is defined by the claims which follow, that scope including all equivalents of the subject matter of the claims.

### Nonlimiting Example Embodiments

Embodiments disclosed herein include:

Embodiment A: introducing a treatment fluid into a target zone in wellbore drilled through a subterranean formation, the treatment fluid comprising: a solvent-based carrier fluid; and a plurality of surface flow modifiers (SFMs), wherein the SFMs are selected from the group consisting of a hydrophobic chemical, a superhydrophobic chemical, an omniphobic chemical, a superomniphobic chemical, an ionic liquid chemical, and any combination thereof; bonding at least a portion of the plurality of SFMs to a rock surface of the subterranean formation within a wellbore at the target zone to at least partially obstruct a rock pore thereof, thereby altering permeation of the rock surface of the subterranean formation to favor hydrocarbon permeation over water permeation through the rock surface of the subterranean formation and into the wellbore; producing hydrocarbons into the wellbore through the rock surface of the subterranean formation; and recovering the hydrocarbons at a surface location.

Embodiment B: a pump fluidly coupled to a tubular, the tubular extending into a target zone in a wellbore drilled through a subterranean formation and containing a treatment fluid, the treatment fluid comprising: a solvent-based carrier fluid; and a plurality of surface flow modifiers (SFMs), wherein the SFMs are selected from the group consisting of a hydrophobic chemical, a superhydrophobic chemical, an omniphobic chemical, a superomniphobic chemical, an ionic liquid chemical, and any combination thereof, and wherein at least a portion of the SFMs bind to a rock surface of the subterranean formation at the target zone in the wellbore to at least partially obstruct a rock pore thereof and alter permeation thereof to favor hydrocarbon permeation over water permeation.

Each of embodiments A and B may have one or more of the following additional elements in any combination:

Element 1: wherein the target zone is a water-producing zone, or a water-producing and carbon dioxide-producing zone.

Element 2: wherein the plurality of SFMs comprise a head portion and a tail portion, the head portion selected from the group consisting of a silane compound, a siloxy compound, an aluminoxy compound, an aluminosilicate compound, a chloroaluminate compound, and any combination thereof, and the tail portion comprising a hydrocarbon chain having four (4) to thirty (30) carbon atoms.

Element 3: wherein the plurality of SFMs comprise a head portion and a tail portion, the head portion selected from the group consisting of a silane compound, a siloxy compound, an aluminoxy compound, an aluminosilicate compound, a chloroaluminate compound, and any combination thereof, and the tail portion comprising an aliphatic cyclic compound, an aliphatic linear compound, an aromatic cyclic compound, or an aromatic linear compound.

Element 4: wherein the plurality of SFMs are selected from the group consisting of an organophosphorous, an organosilane, an organosilicone, an organometallic, a Grignard-based reagent, a Gilman-based reagent, an ionic liquid chemical, and any combination thereof.

Element 5: wherein the plurality of SFMs comprise an organosilane selected from the group consisting of 1,2-Bis(trimethoxysilyl) decane (organosilane), (2-methyl-2-phenylethyl)methyldichlorosilane (organosilane), 4-phenylbutyldimethylchlorosilane (organosilane), and any combination thereof.

Element 6: wherein the plurality of SFMs are selected from the group consisting of a phosphate derivative, an alkoxysilane, a silyl halide, a Grignard-based reagent, a Gilman-based reagent, an organolithium, an organozinc, an ionic liquid chemical, and any combination thereof.

Element 7: wherein the plurality of SFMs comprise an ionic liquid chemical, the ionic liquid chemical selected from the group consisting of a supported ionic liquid membrane, a polymeric ionic liquid, a zwitterionic liquid, an ionic liquid gel, and any combination thereof.

Element 8: wherein at least a portion of the plurality of SFMs alters the permeation of the rock surface of the subterranean formation via a stimuli, the stimuli selected from the group consisting of temperature, ionic strength, pH, (ultra) sonication, electromagnetic radiation, electric discharge, chemical reaction, and any combination thereof.

Element 9: wherein the solvent-based carrier fluid is selected from the group consisting of dibenzyl ether; diethyleneglycol butyl ether; 2-butoxyethanol; diethylene glycol monobutyl ether acetate; ethylene glycol; diesel; hexafluorobenzene; 2H,3H-perfluoropentane; 1,3-dichloro-1,1,2,2,3-pentafluoropropane; and any combination thereof.

Element 10: wherein the water is selected from the group consisting of fresh water, saltwater, brine, seawater, produced water, and any combination thereof.

Element 11: wherein the at least portion of the SFMs bond to the rock surface of the subterranean formation within the wellbore at the target zone via chemical bonding, physical bonding, or a combination of chemical and physical bonding.

Element 12: wherein at least a portion of the plurality of SFMs are immobilized on a support comprised of drill cuttings from the rock surface of the subterranean formation.

Element 13: wherein the subterranean formation is a carbonate-based subterranean formation, a sandstone-based subterranean formation, or a shale-based subterranean formation.

By way of non-limiting example, exemplary combinations applicable to A and B may include, but are not limited to: any one, more, or all of Elements 1-13 in any combination.

Accordingly, the present disclosure provides for various SFMs for use in selectively altering the permeability of a subterranean formation rock surface for permeation of hydrocarbons and prevention or mitigation (render substantially impermeable) for permeation of water.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized that these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and are not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

1. A method comprising:
introducing a treatment fluid into a target zone in a wellbore drilled through a subterranean formation, the treatment fluid comprising:
a solvent-based carrier fluid; and
a plurality of surface flow modifiers (SFMs),
wherein the SFMs are selected from the group consisting of a hydrophobic chemical, a superhydrophobic chemical, an omniphobic chemical, a superomniphobic chemical, an ionic liquid, and any combination thereof;
bonding at least a portion of the plurality of SFMs to a rock surface of the subterranean formation within a wellbore at the target zone to at least partially obstruct a rock pore thereof, thereby altering permeation of the rock surface of the subterranean formation to favor hydrocarbon permeation over water permeation through the rock surface of the subterranean formation and into the wellbore;
producing hydrocarbons into the wellbore through the rock surface of the subterranean formation; and
recovering the hydrocarbons at a surface location.

2. The method of claim 1, wherein the target zone is a water-producing zone, or a water-producing and carbon dioxide-producing zone.

3. The method of claim 1, wherein the plurality of SFMs comprise a head portion and a tail portion, the head portion selected from the group consisting of a silane compound, a siloxy compound, an aluminoxy compound, an aluminosilicate compound, a chloroaluminate compound, fluorocarbon compound and any combination thereof, and the tail portion comprising a hydrocarbon or fluorocarbon chain having four (4) to thirty (30) carbon atoms.

4. The method of claim 1, wherein the plurality of SFMs comprise a head portion and a tail portion, the head portion selected from the group consisting of a silane compound, a siloxy compound, an aluminoxy compound, an aluminosilicate compound, a chloroaluminate compound, and any combination thereof, and the tail portion comprising an aliphatic cyclic compound, an aliphatic linear compound, an aromatic cyclic compound, or an aromatic linear compound.

5. The method of claim 1, wherein the plurality of SFMs are selected from the group consisting of an organophosphorous, an organosilane, an organosilicone, an organometallic, a Grignard-based reagent, a Gilman-based reagent, an ionic liquid chemical, and any combination thereof.

6. The method of claim 1, wherein the plurality of SFMs comprise an organosilane selected from the group consisting of 1,2-Bis(trimethoxysilyl) decane (organosilane), (2-methyl-2-phenylethyl)methyldichlorosilane (organosilane), 4-phenylbutyldimethylchlorosilane (organosilane), and any combination thereof.

7. The method of claim 1, wherein the plurality of SFMs are selected from the group consisting of a phosphate derivative, an alkoxysilane, a silyl halide, a Grignard-based reagent, a Gilman-based reagent, an organolithium, an organozinc, an ionic liquid chemical, and any combination thereof.

8. The method of claim 1, wherein the plurality of SFMs comprise an ionic liquid chemical, the ionic liquid chemical selected from the group consisting of a supported ionic liquid membrane, a polymeric ionic liquid, a zwitterionic liquid, an ionic liquid gel, a responsive ionic liquid, and any combination thereof.

9. The method of claim 1, wherein the plurality of SFMs comprise a responsive ionic liquid chemical, the responsive ionic liquid chemical selected from the group consisting of a responsive supported ionic liquid membrane, a responsive polymeric ionic liquid, a responsive zwitterionic liquid, a responsive ionic liquid gel, and any combination thereof.

10. The method of claim 1, wherein at least a portion of the plurality of SFMs alters the permeation of the rock surface of the subterranean formation via a stimuli, the stimuli selected from the group consisting of temperature, ionic strength, pH, (ultra) sonication, electromagnetic radiation, electric discharge, chemical reaction, and any combination thereof.

11. The method of claim 1, wherein the solvent-based carrier fluid is selected from the group consisting of dibenzyl ether; diethyleneglycol butyl ether; 2-butoxyethanol; diethylene glycol monobutyl ether acetate; ethylene glycol; diesel; hexafluorobenzene; 2H,3H-perfluoropentane; 1,3-dichloro-1,1,2,2,3-pentafluoropropane; and any combination thereof.

12. The method of claim 1, wherein the at least portion of the SFMs bond to the rock surface of the subterranean formation within the wellbore at the target zone via chemical bonding, physical bonding, or a combination of chemical and physical bonding.

13. The method of claim 1, wherein at least a portion of the plurality of SFMs are immobilized on a support comprised of drill cuttings from the rock surface of the subterranean formation.

14. The method of claim 1, wherein the subterranean formation is a carbonate-based subterranean formation.

15. The method of claim 1, wherein the subterranean formation is a sandstone-based subterranean formation.

16. The method of claim 1, wherein the subterranean formation is a shale-based subterranean formation.

17. A system comprising:
a pump fluidly coupled to a tubular, the tubular extending into a target zone in a wellbore drilled through a subterranean formation and containing a treatment fluid, the treatment fluid comprising:
a solvent-based carrier fluid; and
a plurality of surface flow modifiers (SFMs),
wherein the SFMs are selected from the group consisting of a hydrophobic chemical, a superhydrophobic chemical, an omniphobic chemical, a superomniphobic chemical, an ionic liquid chemical, and any combination thereof, and
wherein at least a portion of the SFMs bind to a rock surface of the subterranean formation at the target zone in the wellbore to at least partially obstruct a rock pore thereof and alter permeation thereof to favor hydrocarbon permeation over water permeation.

18. The system of claim 17, wherein the plurality of SFMs comprise a head portion and a tail portion, the head portion selected from the group consisting of a silane compound, a siloxy compound, an aluminoxy compound, an aluminosilicate compound, a chloroaluminate compound, and any combination thereof, and the tail portion comprising a hydrocarbon chain having four (4) to thirty (30) carbon atoms.

19. The system of claim 17, wherein the plurality of SFMs comprise a head portion and a tail portion, the head portion selected from the group consisting of a silane compound, a siloxy compound, an aluminoxy compound, an aluminosilicate compound, a chloroaluminate compound, and any combination thereof, and the tail portion comprises an aliphatic cyclic compound, an aliphatic linear compound, an aromatic cyclic compound, or an aromatic linear compound.

20. The system of claim 17, wherein the subterranean formation is a carbonate-based subterranean formation, a sandstone-based subterranean formation, or a shale-based subterranean formation.
